(19) United States
(12) Patent Application Publication
(10) Pub. No.: US 2010/0107906 A1
(43) Pub. Date: May 6, 2010

(54) Cartridge System

(75) Inventors: Jonathan A. Johnson, Orem, UT (US); Phil Beffrey, Petaluma, CA (US); Rodney Stock, San Rafael, CA (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Provo Craft and Novelty, Inc., Spanish Fork, UT (US)

(21) Appl. No.: 12/477,029

(22) Filed: Jun. 2, 2009

Related U.S. Application Data
(60) Provisional application No. 61/058,178, filed on Jun. 2, 2008.

(51) Int. Cl. B44B 5/00

(52) U.S. Cl. 101/26

(57) ABSTRACT

A multi-cartridge system including a plurality of cartridge connectors configured to receive electronic cutting cartridges, and an external connector for operably connecting the electronic cutting cartridges to an electronic cutting machine. The cartridge connectors are in electrical communication with an external connector.

### CROSS REFERENCE TO RELATED APPLICATIONS

This application claims priority under 35 USC 119(e) to U.S. Provisional Patent Application No. 61/058,178 filed on Jun. 2, 2008, titled “Multi-Cartridge Method and System for a Personal Electronic Cutter”, to Jonathan Aaron Johnson, the contents of which are incorporated in their entirety herein by reference.

### TECHNICAL FIELD

This invention relates to a system and method for multi-cartridge use in a personal electronic cutter.

### BACKGROUND

Personal cutting machines that use cartridges typically only include a single cartridge interface. Such a system may make it difficult for a user to employ designs using multiple cartridges without having to change cartridges frequently. Moreover, the user may not be able to easily keep track of the cartridges.

When multiple cartridges are used, the user may need to store a cartridge, an associated overlay and a user manual for the cartridge. When using many cartridges with an electronic cutter, the user may lose or feel disorganized as to the location of the cartridge, an associated overlay and a user manual.

Thus, a need exists for a system providing an interface for multiple cartridges for the electronic cutter. Moreover, where overlays are used to select the designs, storage for multiple overlays may be helpful to the user.

### BRIEF DESCRIPTION OF THE DRAWINGS

The features and inventive aspects will become more apparent upon reading the following detailed description, claims, and drawings, of which the following is a brief description:

FIG. 1 is a front view of a multi-cartridge system.

FIG. 2 is a top view of the multi-cartridge system of FIG. 1 showing the cartridge connectors.

FIG. 3 is a cut-away view of the multi-cartridge system of FIG. 1 showing the cartridges and overlays/manuals.

FIG. 4 is a front view showing two stacked multi-cartridge systems.

FIG. 5 is a perspective view of a multi-cartridge system attached to a stand-alone personal electronic cutting system.

FIG. 6 is a perspective view of a multi-cartridge system attached to a personal electronic cutter and a personal computer.

FIG. 7 is a system view of the multi-cartridge system of FIG. 1.

### DETAILED DESCRIPTION

Referring now to the drawings, illustrative embodiments are shown in detail. Although the drawings represent the embodiments, the drawings are not necessarily to scale and certain features may be exaggerated to better illustrate and explain novel aspects of an embodiment. Further, the embodiments described herein are not intended to be exhaustive or otherwise limit or restrict the claims to the precise form and configuration shown in the drawings and disclosed in the following detailed description. This application claims priority under 35 USC 119(e) to U.S. Provisional Patent Application No. 61/058,178 filed on Jun. 2, 2008, titled “Multi-Cartridge Method and System for a Personal Electronic Cutter”, to Jonathan Aaron Johnson, the contents of which are incorporated in their entirety herein by reference.

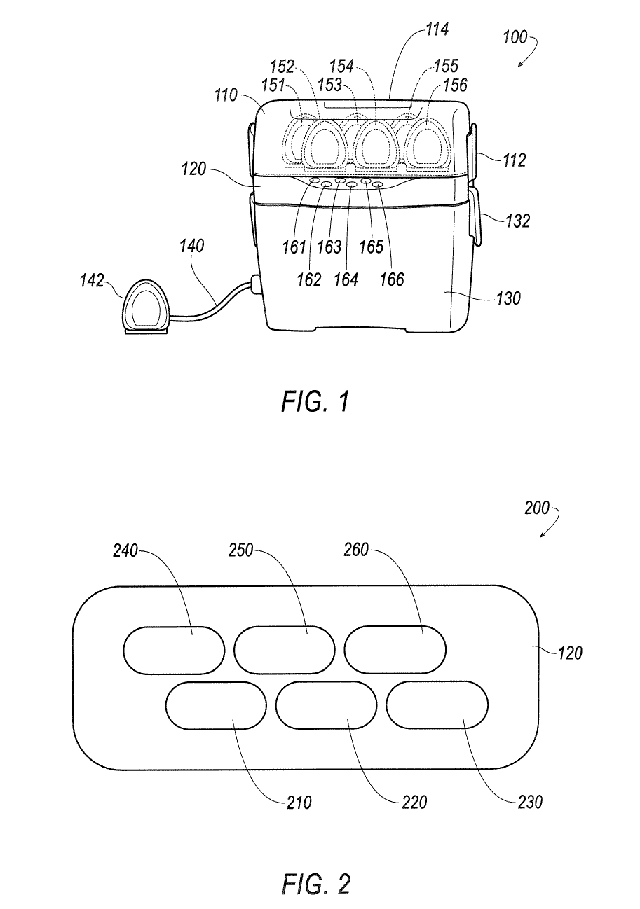

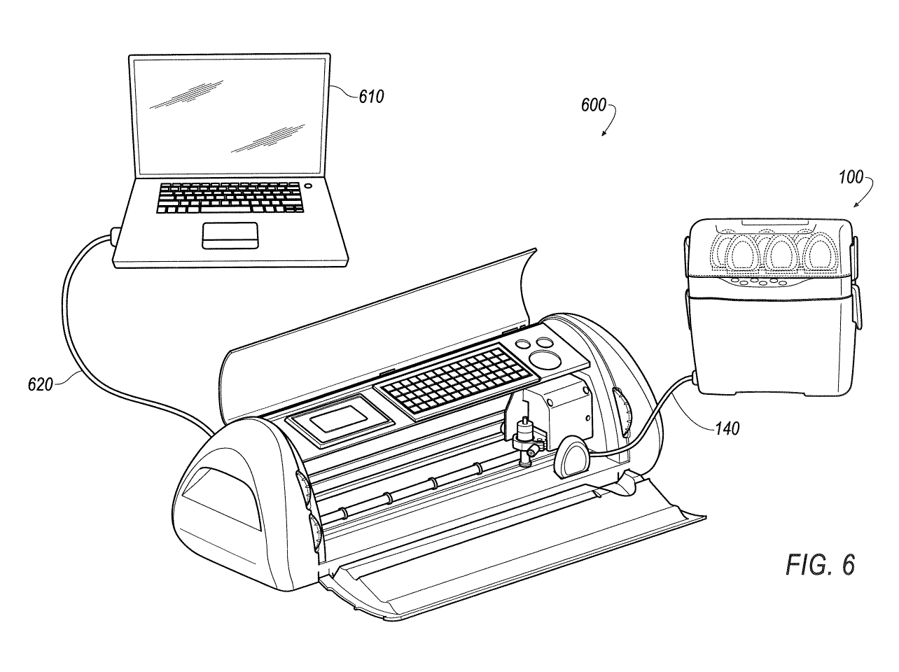

Referring now to FIG. 1, as described herein, the multi-cartridge system 100 may be embodied to allow six (6) cartridges to be recognized simultaneously by a personal cutter 10 (see FIG. 6). The personal cutter 10 may be, for example, a Cricut® machine. The multi-cartridge system 100 may eliminate the need for the crafter to remove and replace each of the six (6) cartridges in order to cut from each. The multi-cartridge system 100 may be a natural partner to software that interfaces with the personal cutter 10, which would allow the software to read each of the cartridge's content. In this way, the design using the software may allow for easy cross-cartridge use. Moreover, the personal cutter 10 may daisy-chain multiple multi-cartridge systems 100 to allow additional cartridges to be used simultaneously for cutting.

The multi-cartridge system may be used with or without a computer interface (e.g., software running on a computer). When using the PC software, the personal cutter 10 may sense any and all cartridges plugged into the multi-cartridge system 100 chain and cut them automatically without a pause (that may be typical when a new cartridge is requested by the personal cutter 10). This makes using multiple cartridges more convenient to the user. When not using the PC software, the user simply presses the appropriate button to activate the desired cartridge. This allows the user to push a button to select a cartridge, rather than having to remove and replace a cartridge to access new artwork.

The multi-cartridge system also provides storage for manuals and overlays used with the personal cutter 10. The convenient base compartment holds multiple manuals and corresponding overlays. When using more than one multi-cartridge system, the user can easily stack them on top of each other and still have the selection buttons exposed for use. Owning multiple multi-cartridge systems 100 may be appealing since the user can categorize and group up to six cartridges together for easy connection at any time, and leave them in the multi-cartridge system when not in use.

Multi-cartridge system 100 shows a base 130, lower latches 132, upper latches 112, upper lid 110, carry handle 114, lower lid 120, a connector cable 140, a electronic cutter interface 142, cartridges 151-156, and user selection buttons 161-166. Electronic cutter interface 142 may be used to plug multi-cartridge system 100 into an electronic cutting machine to provide the electrical interface to transfer data to and from the cartridges 151-156 and the electronic cutter.

To activate a particular cartridge a user may push the associated button. For example, if the user desired to activate cartridge 151, the user may push button 161. As shown in FIG. 1, the mapping of cartridge locations and buttons are mapped in a similar pattern that a user would readily recognize. When the user was finished with cartridge 151, they may desire to activate another cartridge. In that case, they might activate cartridge 154 by pushing button 164.

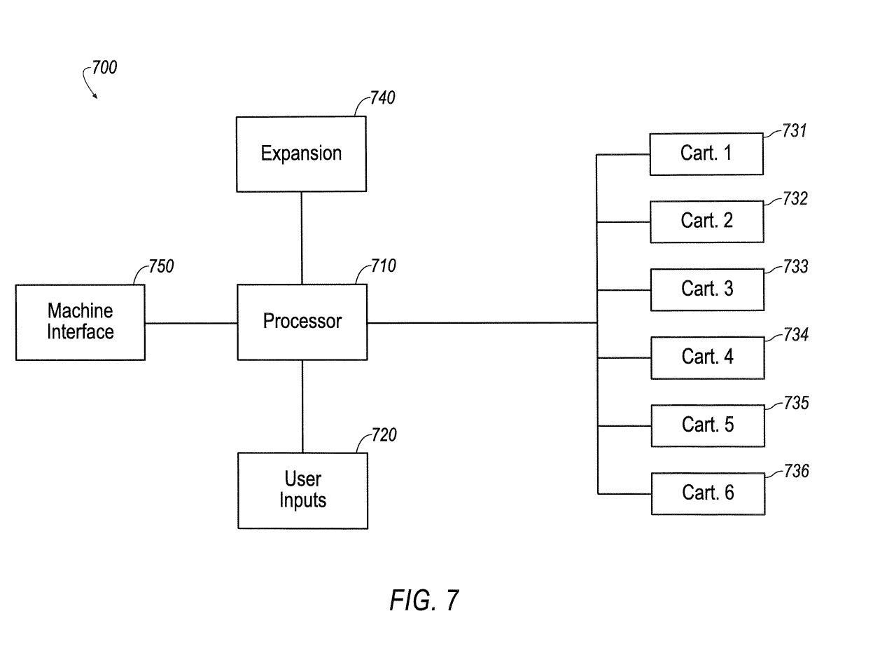

When used with a personal computer, the embedded processor (see FIG. 7) may be able to detect the communication with the personal computer and may provide the personal computer with the identifications of all cartridges plugged in. Thus, the personal computer interface may provide complete access to the cartridges without user any user interaction. Moreover, the interface may provide the cartridge content as well so that the content may be provided in whole or in part to the personal computer. This may be advantageous when the user desires to cut a design having content from more than one cartridge. In this case, the personal computer may receive the content to be cut from multiple cartridges and then schedule the cutting operation without requiring user interaction.

Upper latches 112 allow the upper lid 110 to be removed from lower lid 120. Upper lid 110 provides security to the cartridges 151-156 so that they are not knocked free from their connectors. Lower latches 132 allow base 130 to be removed from lower lid 120. This may allow the user to place lower lid 120 on a surface for use, while allowing access to the contents of the base 130 (e.g., for locating manuals and/or overlays).

FIG. 2 shows a plurality of cartridge connectors 210, 220, 230, 240, 250, 260 positioned at lower lid 120. Cartridge connectors 210-260 allow a user to plug and unplug cartridges into the multi-cartridge system 100.

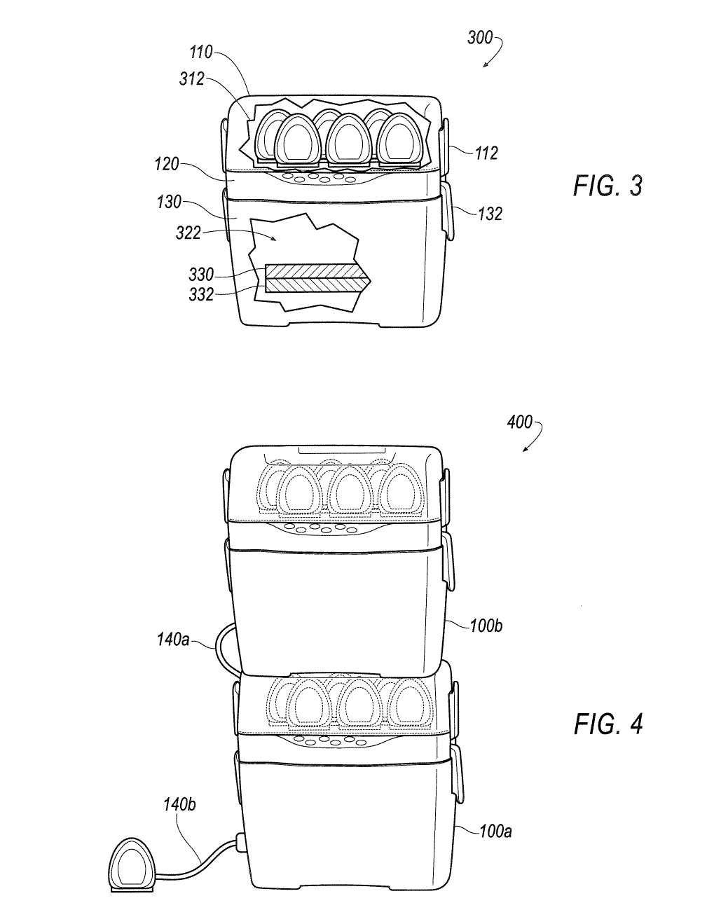

FIG. 3 shows an upper cut-away portion 312 through upper lid 110 to expose the cartridges. Upper lid 110 may also be provided as a clear material so that the user may easily identify the cartridges residing within multi-cartridge system 100. By identifying the cartridge, the user may manually select the cartridge for use by the buttons 161-166. Also shown is a lower cut-away portion in the base 130 showing a storage cavity 322 that allows the user to keep manuals 330 and overlays 332 with multi-cartridge system 100 and with the cartridges in use. In general, the base 130 is separable from the lower lid 120 to allow the user to place lower lid 120 on a table while in use, and allows the user to retrieve overlays and/or manuals from base 130. However, for storage or when using the cartridges with a personal computer, base 130 may be attached to lower lid 120 when the overlays are not in demand. Such a system allows the cartridges and the accessories (e.g., overlays and manuals) to be kept together.

FIG. 4 shows the stacking arrangement of multi-cartridge systems 100a, 100b, and a cable 140a that allows each multi-cartridge system 100a, 100b to communicate through cable 140b (e.g., to the personal electronic cutter). Although the stacking is not necessary for daisy-chaining more than one multi-cartridge system 100, the stacking may assist in reducing the overall footprint of multiple multi-cartridge systems 100. Although only two

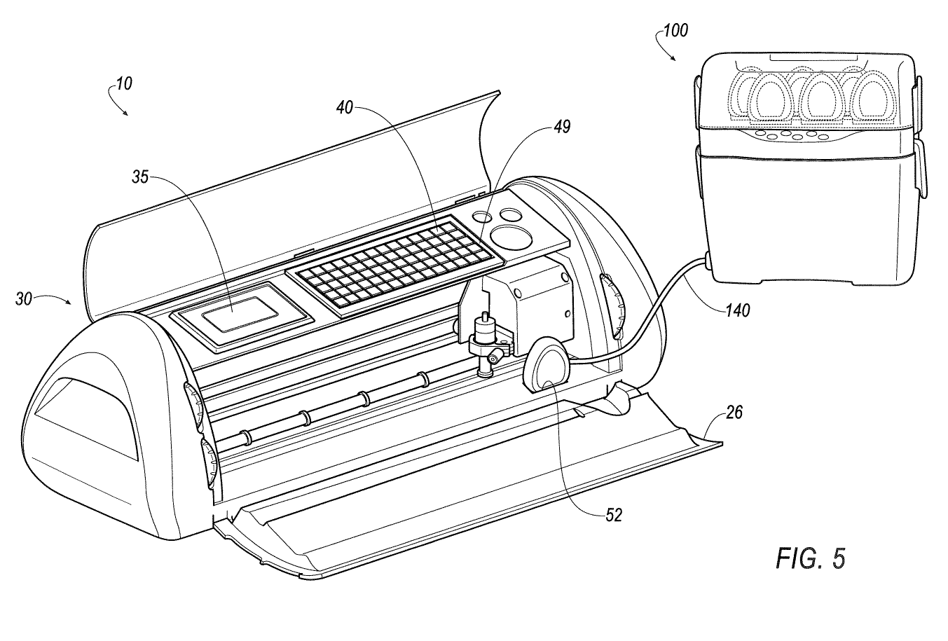

Now referring to FIGS. 1 and 5, FIG. 5 shows multi-cartridge system 100 connected through cable 140 to personal electronic cutter 10 in a stand-alone configuration. The personal electronic cutter 10 includes a connector 52 that electronic cutter interface 142 plugs into. The user may select any of cartridges 151-156 using buttons 161-166. The overlay 40 may be removed from base 130 when the cartridge is selected so that the user can utilize the full functionality of the selected cartridge. Moreover, the selected cartridge will display its art on the graphical display 35.

Now referring to FIGS. 1 and 6, FIG. 6 shows multi-cartridge system 100 connected through cable 140 to personal electronic cutter 10 in a computer-interfaced configuration. A personal computer 610 is also connected to personal electronic cutter 600 via a cable 620, typically a USB cable interface. Such a computer-interfaced configuration allows the user to utilize the content from all of the connected cartridges (e.g., connected to multi-cartridge system 100) at the same time. Thus, no user selection of a cartridge is necessary since the computer-interfaced configuration can read and use all content stored on all connected cartridges at the same time. In an embodiment, the personal electronic cutter may be, for example, a Cricut® personal electronic cutter. Such a device is described in detail in application Ser. No. 11/457,419, filed Jul. 13, 2006, to Robert Workman et al., the contents of which are incorporated herein by reference. However, it will be appreciated that the personal electronic cutter is not limited to the example shown.

FIG. 7 is a system 700 view of the multi-cartridge system of FIG. 1. System 700 may include a processor 710, user inputs 720, an expansion connector 740, cartridge connectors 731-736, and a machine interface 750. User inputs are shown in FIG. 1 as switches 161-166. Processor 710 may be a generic data processor having inputs and outputs. In general, processor 710 may be embedded in multi-cartridge system 100. Moreover, processor 710 may include firmware or other software systems that allow communication with cartridges 151-156 (see FIG. 1), user buttons 161-166, machine interface 750, expansion connector 740, and the ability to read and/or reprogram cartridges 151-156.

User inputs 720 may provide sensing of pushbuttons such as switches 161-166 (see FIG. 1). The user inputs may be, for example, configured to detect mechanical switching, resistive switching, or other types of detection of user inputs. Cartridge connectors 731-736 may be configured to receive cartridges 151-156, such as are used with the personal electronic cutter 600 (as shown in FIG. 6). Expansion connector 740 may include a connector configured to receive electronic cutter interface 142 (see FIG. 1) so that multiple systems 700 to communicate with each other, and ultimately the personal computer and/or personal cutting machine. Thus, the expansion connector 740 provides an electrical communication path for networking multiple multi-cartridge systems 100. However, the user may decide whether to use multiple multi-cartridge systems 100, or a single multi-cartridge system 100 at a time.

Machine interface 750 may be used to connect with a personal electronic cutter 600, and/or a personal computer 610. The personal computer connection may be direct (e.g., through a USB connection) or through the personal electronic cutter 600 (as shown in FIG. 6). Alternatively, multi-cartridge system 100 may include a USB interface for connecting directly with a personal electronic cutter and/or a personal computer.

In the example shown in FIG. 6, the multi-cartridge system 100 communicates with the electronic cutter 600 through cable 140 and a first interface type, shown as an electronic cutter interface 142 (see FIG. 1). The second interface type to connect with a personal computer may be done via cable 620, typically a USB interface. Thus, the communication with multiple devices may be completed using multiple interface types, including a cartridge connector and a personal computer peripheral connector (e.g. USB). Moreover, the components of the system may allow for the transmission and reception of information from various components using the various communication systems. In this way, the cartridge content may be individually user-selectable for the electronic cutter or the cartridge content may be used as a whole by the personal computer.

When using the multi-cartridge system 100 with a personal computer, the software may recognize the cartridge and use a graphical overlay on the computer screen. These overlays may be stored by the software system and do not require the physical overlay to be used. Thus, this allows the user to utilize each of the cartridges in the multi-cartridge system 100 without having to locate and place the overlay on the personal electronic cutter.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A multi-cartridge system comprising:
a plurality of cartridge connectors configured to receive electronic cutting cartridges;
an external connector for operably connecting said electronic cutting cartridges to a, electronic cutting machine, said cartridge connectors being selectively in electrical communication with an external connector.

2. The system of claim 1, further comprising:
an extension connector, for connecting at least one other multi-cartridge system to the external connector.

3. The system of claim 1, further comprising:
a base configured to hold accessories related to said electronic cutting cartridges.

4. The system of claim 1, further comprising:
a substantially transparent upper lid covering said electronic cutting cartridges.

5. The system of claim 1, further comprising:
a user selection system configured to allow a user to select a specific cartridge for use with said electronic cutting machine.

6. The system of claim 1, further comprising:
a personal computer connector, providing access to each electronic cutting cartridges to a personal computer, and also allowing said personal computer access to said external connector.
